(19) United States
(12) Patent Application Publication
(10) Pub. No.: US 2024/0241483 A1
(43) Pub. Date: Jul. 18, 2024

(54) MONITORING AND/OR CONTROLLING A PLANT VIA A MACHINE-LEARNING REGRESSOR

(71) Applicant: BASF SE, Ludwigshafen am Rhein (DE)

(72) Inventors: Phillip RUEHL, Schwarzheide (DE); Alexander BADINSKI, Ludwigshafen (DE); Gennadij HEIDEL, Schwarzheide (DE)

(21) Appl. No.: 18/559,102

(22) PCT Filed: May 27, 2022
(86) PCT No.: PCT/EP22/64391

§ 371 Date: Nov. 6, 2023

(30) Foreign Application Priority Data
Jun. 7, 2021 (EP) 21177958.2

(51) Int. Cl. G05B 13/02

(52) U.S. Cl. CPC G05B 13/0265

(57) ABSTRACT

Disclosed herein is a computer-implemented regressor for simulating, monitoring and/or controlling a batch plant. The batch plant is implemented to receive one or more educts having associated educt quality parameters (x₁, x₂), to process the educt(s) where the process has associated process parameters (yⱼ), and to output a product having associated product quality parameters (Q₁, Q₂). The regressor includes at least two regressor units based on machine-learning principles, each regressor unit having an input for receiving input data, and an output for outputting output data. A first regressor unit is implemented to receive the educt quality parameters (xᵢ) and to output at least one educt impact parameter (R₁). And a second regressor unit is implemented to receive the educt impact parameter (R₁) and l process parameters (yⱼ) and to output at least one product quality parameter (Qⱼ).

The present disclosure relates to methods, regressors, in particular involving artificial neural network systems, and control devices for simulating, monitoring and/or controlling a plant. Further, methods for training artificial neural network systems are provided. In particular, models based on artificial neural networks (ANN) are depicted that are suitable for simulating batch processes where educts are transformed into products by a batch-processing unit and which are suitable to monitoring and/or controlling a batch plant.

In batch processing or batch plants, the production of multiple products occurs with the same set of equipment or processing units, for example a chemical or biological reactor. On the one hand, it is desirable to optimize a particular process involving certain educts that are processed into the desired product. On the other hand, scheduling a batch operation using a single processing unit can be improved if processes are accurately modeled and simulated.

In conventional approaches, simulations of chemical reactions occurring in a batch process use so-called whitebox models that are based on rigorous models or first principles. Whitebox models generally require a large amount of computational power and resources due to the complex physiochemical systems to be modelled involving non-linear equations.

Another approach are so-called blackbox models that were developed in the past and rely on machine-learning concepts. For example, neural networks can be used to predict specific properties of a product or its quality based on input data including process characteristics and educt characteristics. Such neural networks need to be trained with a plurality of data sets that sometimes are not available. Further, a conventional blackbox model based on an artificial neural network needs to be retrained, if conditions in the batch plant to be modeled, a desired product quality and/or the educt characteristics change, thus rendering conventional approaches inflexible.

A further approach are hybrid models as combinations of whitebox models and blackbox models. Document WO 2020/227383 A1 discloses computer-based process modeling and simulation methods and systems combining first principles models and machine learning models to benefit where either model is lacking. In one example, measured input values are adjusted by first principles techniques. A machine learning model of the chemical process of interest is trained on the adjusted values. In another example, a machine learning model represents the residual between a first principles model prediction and empirical data. Residual machine learning models correct physical phenomena predictions in a first principles model of the chemical process. In another example, a first principles simulation model uses the process input data and predictions of the machine learning model to generate simulated results of the chemical process.

Document WO 2020/058237 A2 discloses a method and a system capable of predicting values for product quality attributes of a chemical compound or of a formulation thereof as an outcome of a multistep production process, wherein the whole process or process steps are characterized by process parameters. It is achieved by executing a multivariate data analysis of the process data in a quality-prediction model, which specifies or represents mathematical relationships between quality attributes and process parameters of the production process or of sub-processes thereof. The quality-prediction model is obtained by mathematical modelling of historical process data, most preferred using neural network models in combination with empirical process knowledge gained over time.

It is an object of the present disclosure to provide improved methods and systems for monitoring and/or controlling plants.

Aspect of the independent claims solve this problem.

This disclosure provides a computer-implemented regressor for simulating, monitoring and/or controlling a plant. The plant can be implemented to receive one or more educts having associated educt quality parameters, to process said educt(s) wherein the process has associated process parameters, and to output a product having associated product quality parameters. The regressor comprises at least two regressor units, each regressor unit comprising an input for receiving input data, and an output for outputting output data. Within the regressor, a first regressor unit is implemented to receive said educt quality parameters and to output at least one educt impact parameter; and a second regressor unit is implemented to receive said educt impact parameter and said process parameters and to output at least one product quality parameter. The regressor and/or regressor units are based on machine-learning principles.

In embodiments an artificial neural network (ANN) system for simulating, monitoring and/or controlling a batch plant is disclosed. The batch plant is implemented to receive one or more educts having associated educt quality parameters, to process said educts wherein the process has associated process parameters, and to output a product having associated product quality parameters. The ANN system comprises at least two ANNs, each ANN comprising an input layer having input nodes for receiving input data and an output layer having output nodes for outputting output data. The first ANN is implemented to receive said educt quality parameters and to output at least one educt impact parameter. The second ANN is implemented to receive said educt impact parameter and said process parameters and to output at least one product quality parameter.

The applicant found that nested or concatenated ANNs are suitable regressors for solving separable problems posed by batch plants. Thus, the disclosed regressor can be implemented as an ANN system involving ANNs.

In the proposed ANN system, data relating to the educts, i.e. educt quality parameters, and process data relating to the actual process performed in the batch plant, i.e. process parameters, are considered separately. The first ANN models/simulates the impact of educt properties in terms of the educt quality parameters, and the second ANN models/simulates the, e.g. chemical or biological, process, which is at least partially driven by process parameters that can be observed or set during the operation of the batch plant. The second ANN also receives input from the first ANN so that product quality parameters can be reliably predicted.

It is understood that a respective ANN includes an input layer having input nodes for receiving input data and an output layer having output nodes for outputting output data. The ANNs may also comprise hidden layers between the input layer and the output layer. Generally, a respective ANN is characterized by configuration data at least including bias values and weight values for each node within the ANN. This configuration data is obtained by training the respective ANN.

One may also refer to a trained ANN as a model for the chemical reacting occurring in a process unit of the batch plant. Trained ANNs are also considered regressors for the underlying problem to map input data (e.g. educt and process characteristics) onto output or target data (e.g. product characteristics).

The proposed approach of separating the complex problem of mapping a variety of educt quality parameters and process parameters onto a product quality parameter allows for an efficient use of sparse data sets in training the ANNs or models, respectively. Embodiments of the ANN system allow for sharing training data sets used for different products produced by the same or similar batch plant. In particular, the process model or second ANN can benefit from trained first ANNs or educt models for similar or same educts used in different batch plant processes. For example, the ANN system allows to change the educt model by updating configuration data for the first ANN, if an educt is changed but the overall batch process modeled by the second ANN is essentially unaltered. Hence, the trained partial ANN of the unchanged component in a batch plant process remains. Doing so, the amount of required training data is reduced with respect to a conventional artificial neural network that needs to be completely trained with sets of educt quality parameters and process parameters to target or model product quality parameters.

It occurs that, according to investigations of the applicant, the resulting model or neural network system for simulating a batch plant is robust against noise in training data. In embodiments, the partial blackbox model in terms of the first ANN or educt model describes an impact of the educts being independent of the plant or chemical process set-up. Hence, the first ANNs can be used in connection with alternative batch plants or batch plant units that are modeled by alternative second ANNs. Thus, in particular, the trained first ANNs can be recycled and only sparse training data for setting up the second ANN or process model for the alternative batch plant needs to be used.

In embodiments the output product quality parameters are generated in a computer-readable form, displayed and/or used to control, schedule, or adapt the batch plant, in particular by a control device.

In embodiments, the second ANN is based on training data sets including process parameters and product target variables corresponding to product quality parameters associated to a respective product. For example, process parameters can include a measured observable during the chemical reaction, a temperature value, a maximum temperature value, a time span, a reaction span, a storage time of a catalyst, a number of free isocyanate groups or other characteristics of a time series. One may contemplate of other process parameters that influence the chemical reaction in the batch reactor.

Product quality parameters may include viscosity values of the product, a hardness value, a roughness value, drug interaction effects, a pH value or a solubility. One may contemplate of other product quality parameters that characterize the obtained product or the product during the chemical process or reaction in the batch plant.

In embodiments of the ANN system, the first ANN is trained based on training data sets including the educt quality parameters and a residual of the trained second ANN as target variable for the educt impact parameter, both the educt quality parameter and the residual corresponding to a respective product. The residual or prediction error of the second ANN can be due to sparse availability of training data sets and is used to train the first ANN modeling the educt quality. The educt quality parameter may include a viscosity value, a hydroxyl value, a concentration value, a color parameter and the like. One may contemplate of other educt quality parameters.

The ANN system can be seen as a concatenated system of first and second ANNs. In embodiments of the ANN system, a system comprises:
a plurality of first ANNs wherein each ANN of the first ANNs correspond to an educt and is implemented to receive corresponding educt quality parameters and implemented to output at least one corresponding educt impact parameter; and
a plurality of second ANNs wherein each ANN of the second ANNs corresponds to a process for producing a product and is implemented to receive corresponding process parameters and a combination of educt impact parameters from the first ANNs and implemented to output a corresponding product quality parameter.

One may contemplate associating the first ANNs to different educts and the second ANNs to batch processes having specific associated process parameters. The outputs from the first ANNs can be combined, weighted and fed into the second ANNs. For example, each second ANN may receive a linear combination of educt impact parameters from the first ANNs. As a result, the ANN system allows to predict product quality parameters for products that are produced in the batch process by combining one or more of the educts wherein the educts are characterized by the educt quality parameters.

It is understood that “an ANN corresponding to an action” is interpreted as the ANN modeling the action. Hence, “a second ANN corresponding to a certain product” is an ANN that is trained and setup to output approximate product quality parameters in response to process parameters associated to the production process for the given product.

In embodiments of the ANN systems, at least one of the ANN is a feed-forward ANN. In embodiments, Bayesian neural networks can be used as ANNs. One may contemplate that at least one ANN further comprises hidden nodes between input and output nodes.

According to an aspect of this disclosure, a control device for controlling a batch plant is proposed. The batch plant is implemented to receive one or more educts having associated educt quality parameters, to process said educts wherein the process has associated process parameters, and to output a product having one or more associated product quality parameters. The control device comprises an ANN system as disclosed above or below with respect to embodiments, wherein the control device is implemented to adapt a process as a function of the product quality parameter output from the second ANN in response to adapted process parameters. For example, based on the ANN system's simulation of the process within the batch plant, the process and thus the associated process parameters are changed by the control device to obtain a desired product quality.

In embodiments of the control device, the control device comprises a computer processing device implemented to perform operations implementing the ANN system, and to carry out an optimization algorithm for adapting process parameters such that the product quality parameters output from the second ANN correspond to a predetermined product quality.

Other aspects of this disclosure provide for a method for training a regressor, e.g. in terms of an ANN system as disclosed above or below with respect to certain embodiments. The training method comprises at least one of the steps of:
providing for a first and at least one second product, a plurality of trainings data sets, each training data set including educt quality parameters, process parameters, and a product target variable corresponding to a product quality parameter associated to the product;
training the second ANN based on training data subsets including the process parameters and the product target variables corresponding to a first product thereby obtaining a first residual for each training data subset;
training the second ANN based on training data subsets including the process parameters and the product target variables corresponding to at least one further product, thereby obtaining a second residual for each training data subset; and
training the first ANN based on training data subsets including the educt quality parameters and the residual as target variable for the educt impact parameter, both corresponding to the first product and based on further training data subsets including the educt quality parameters and the residual as target variable for the educt impact parameter, both corresponding to the at least one further product.

The training method may include training the first ANN based on the training data set for all products containing a specific educt including the quality parameters for this educt and the residuals from the previous (training) step as the targets. This is preferably done for each educt.

According to aspects of the training method above, the first ANN is trained to provide the residuals of the second ANN, thus reducing the need of a large number of training data subsets or sets.

In embodiments of the training method, for each product, the step of training the second ANN based on trainings data subsets including the process parameters, the educt impact parameters output from the trained first ANN in response to the educt quality parameters associated to the educt use for producing the respective product and the product target variable corresponding to the product quality parameter associated to the respective product is carried out. Hence, the second ANNs receive additional input from the trained first ANN.

In embodiments of the training method, the step of training the first ANN and the step of training the second ANN based on training data subsets including the process parameters, the educt impact parameter output from the trained first ANN in response to the educt quality parameters associated to the educt use for producing the respective product, and the product target variable corresponding to the product quality parameter associated to the respective product are repeatedly carried out.

In embodiments, the training method further comprises:
generating said training data sets by operating the batch plant and measuring process parameters and product quality parameters; and/or
generating said training data sets deploying a whitebox-numerical model for simulating batch plant process based on educt quality parameters and generating process parameters and product quality parameters.

According to an aspect of this disclosure, a method for simulating, monitoring and/or controlling a batch plant, wherein the batch plant is implemented to receive one or more educts having associated educt quality parameters, to process said educts wherein the process has associated process parameters, and to output a product having associated product quality parameters, the method comprises the step of using an ANN system described above or below with respect to certain embodiments, wherein the ANN system is trained according to the training method as disclosed above or below with respect to embodiments.

It is understood that regressor units are not necessarily implemented as ANNs, and that this disclosure also encompasses suitable configurations of other regressor units. Hence, throughout this disclosure the expression “ANN” may be replaced by “regressor unit” to fully appreciate the scope of the invention. A regressor unit can be implemented as a computer-implemented regression method, e.g. in terms of a software function or service.

According to a further aspect, this disclosure relates to a computer program product comprising computer-readable instructions causing a computing system including one or more processing devices, in response to executing the machine-readable instructions, to perform the above-described methods and functions for simulating, monitoring and/or controlling a batch plant.

In embodiments, a computer-program product comprises a program code for executing the above-described methods and functions by a computerized control device when run on at least one control computer. A computer program product, such as a computer program means, may be embodied as a memory card, USB stick, CD-ROM, DVD or as a file which may be downloaded from a server in a network. For example, such a file may be provided by transferring the file comprising the computer program product from a wireless communication network.

Further possible implementations or alternative solutions of the invention also encompass combinations—that are not explicitly mentioned herein—of features described above or below in regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

FIG. 1 shows a schematic diagram of an embodiment for batch plant.

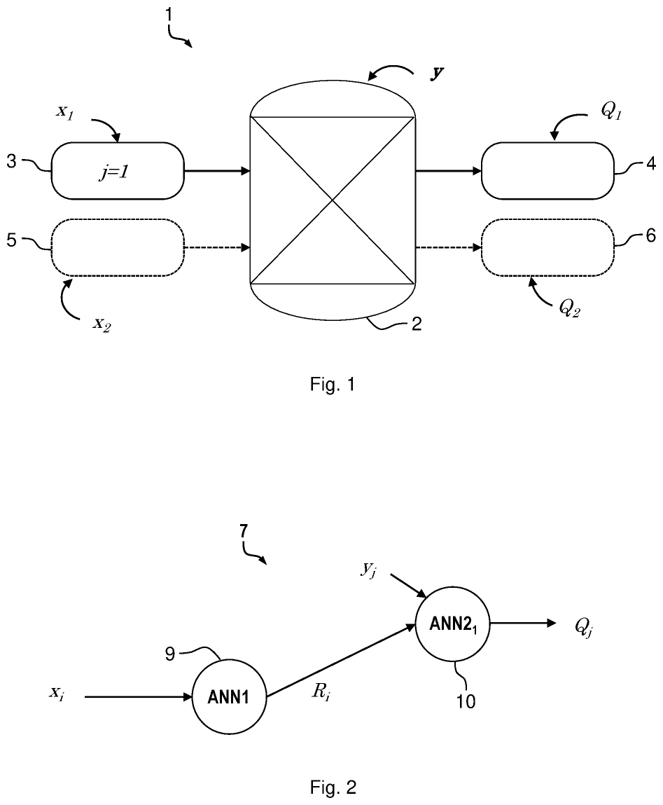

FIG. 2 shows a schematic diagram of a first embodiment of an ANN system.

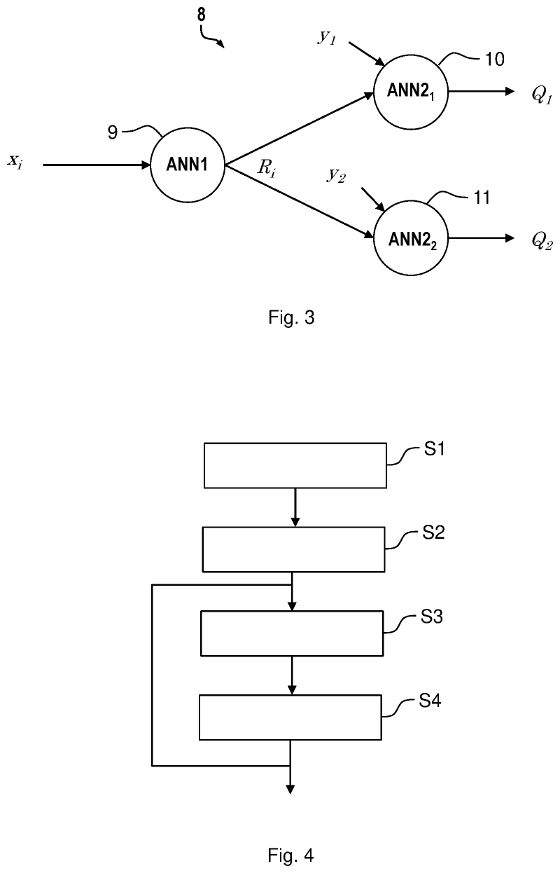

FIG. 3 shows a schematic diagram of a second embodiment of an ANN system.

FIG. 4 shows a flow chart involving method steps for training embodiments of the ANN system.

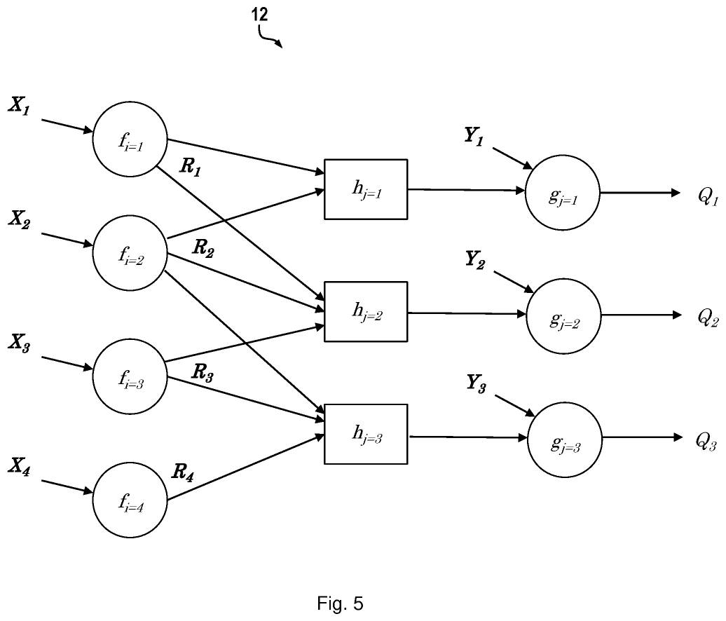

FIG. 5 shows a schematic diagram of a third embodiment of an ANN system.

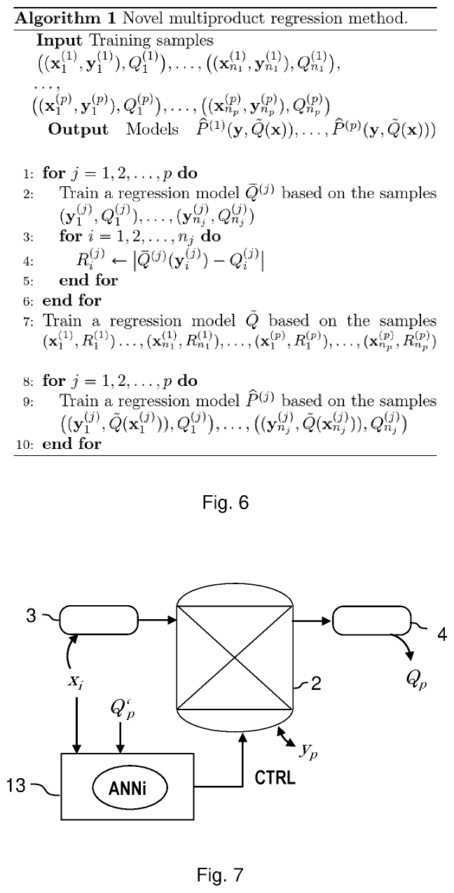

FIG. 6 shows an algorithm for training embodiments of the ANN system.

FIG. 7 shows a schematic diagram of an embodiment for a control system for a batch plant.

FIG. 1 shows a schematic diagram of an embodiment for a batch plant. The batch plant 1 comprises a processing unit 2 which is, for example a continuously stirred tank reactor. The tank reactor 2 can be used to process various educts under specific process parameters to produce a product. Product can be, for example intermediate products of a pre-polymer synthesis, polyols, coatings, or other chemical, pharmaceutical or biological compositions.

In the example of FIG. 1, a single input educt 3 is indicated which undergoes processing in the reactor 2 and results in a product 4. One may attribute specific educt quality parameters to the educt 3 which is indicated by the label x₁. Educt quality parameters may include specific properties of the educt 3, for example a reactivity, a hydroxyl number or specific isomers. In the reactor 2, a chemical reactional process takes place that may be characterized by process parameters y, for example a process parameter can be a temperature profile or time series of an observable within the reactor 2. After the reactional process in reactor 2 is finished or stopped, product 4 can be retrieved having specific quality parameters indicated as Q₁. For example, the quality parameter Q₁ may refer to the purity or concentration of a substance within the product 4.

The batch processing unit 2 can be used for other products. For example, in dashed lines, an alternative educt 5 having an educt quality parameter x2 is depicted, the batch process then leads to an alternative product 6 having product quality parameters Q₂. It is desirable to predict the impact of the educts 3, 5 and applied process parameters yon the products 4, 6 and in particular their product quality parameters. This problem can be written as:

$$( x , {y}_{j} ) ↦ {Q}_{j} ( x , {y}_{j} ) \qquad ( equation 1 )$$

where j stands for the j-th product of all potential products {1, 2, . . . p} in this disclosure. A model or simulation of the batch process needs to map the combination of educt quality parameters x and process parameters y; onto the product quality parameter Q; for each product j. The input vector x describes quality measurements of educts, for example substance concentrations, viscosity measurements, color parameters or the like. The input vector y; refers to process parameters, that can be measured during the production of the product in the reactor 2. One may can contemplate of time series features, such as maximum, minima or mean values or physical observables like temperature or pressure values as process parameters. The output product quality parameter Q is a scalar and describes a desired quality of the product j.

FIG. 2 shows a schematic diagram of a first embodiment of an ANN system implemented to model or simulate the batch process, for example implemented in reactor 2 of FIG. 1. The ANN system 7 comprises a first ANN 9 and a second ANN 10. The underlying ANN models or regressors are labeled ANN1 and ANN2₁. The ANNs 9, 10 are, for example, shallow ANNs having an input layer with input nodes for receiving input data and an output layer having output nodes for outputting output data. The configuration of the ANNs 9, 10 is defined by configuration data including bias values and weight values for each node in the respective ANN (not shown).

The first ANN 9 receives the educt quality parameters xᵢ for educts involved in producing the desired product having a predetermined product quality parameter Qⱼ. The first ANN 9 outputs an educt impact parameter Rᵢ to an input node of the second ANN 10. The second ANN 10 further receives the process parameters yⱼ for product j in the reactor 2. The second ANN 10 outputs the predicted quality parameter Qⱼ. Hence, the embodiment of an ANN system 7 maps the educt quality parameters xᵢ and process parameters yⱼ onto the product quality parameter Qⱼ. It is assumed that the problem depicted in equation 1 can be written as:

$${Q}_{j} ( x , {y}_{j} ) = {\tilde{Q}}_{j} ( f ( x ) , {g}_{j} ( {y}_{j} ) ) . \qquad ( equation 2 )$$

Equation 2 assumes that the mappings or functions for the product quality parameters Qⱼ are separable, wherein function ƒ depends on the educt quality parameters xᵢ and function g on the process parameters yⱼ. It is an advantage if the educt quality parameters xᵢ influence the reaction kinetics according to the process in the reactor in a similar way. The ANN system 7 in FIG. 2 solves a regression problem that can be written as:

$${min}_{w , b} C ( X ; w , b ) ) = {( Q ( X ) - \hat{P} ( X ; w , b ) )}^{2} \qquad ( equation 3 )$$

wherein \hat{P}(X; w, b) refers to the regressor for the true value Qⱼ. The regressor \hat{P}(X; w, b) refers to the model implemented by the trained ANNs 9, 10, wherein w refers to the weights used within the neural networks 9, 10, and b to the bias values used to implement the nodes within the ANNs 9, 10. X includes the educt quality and process parameters.

Generally, the ANN system 7 shown in FIG. 2 is capable of simulating the batch process or reactor 2, respectively. The configuration of the ANN system 7 in terms of a first and a second ANN 9, 10 dedicated to modeling the influence of educt quality parameters xᵢ on the one hand (ANN1) and the influence of process parameters y; on the other hand (ANN2₁) allows for an efficient training and set-up of the configuration data for the ANNs 9, 10.

FIG. 3 shows a schematic diagram of a second embodiment of an ANN system 8. The ANN system 8 includes a first ANN 9 and two second ANNs 10, 11 that are labeled as ANN2₁ and ANN2₂. The labels refer to the model that is implemented through the ANN configuration data, i.e. the biases and weights and number of nodes and their topology. The first second ANN 10 receives the educt impact parameter Rᵢ from the first ANN 9 and process parameters y₁ that describe or characterize the batch process leading to product j=1 having the product quality parameter Q₁. The other second ANN 11 receives alternative process parameters y₂ characterizing the process leading to alternative product j=2 having the product quality parameter Q₂. Models ANN1, ANN2₁ and ANN2₂ are implemented as shallow neural networks, for example Baysian-type neural networks, which dispense with the need for the validation of data sets when training.

FIG. 4 shows a flowchart involving steps for training the ANN system 7, 8 shown in FIG. 2 or 3. In a first step S1, the ANN2₁ and ANN2₂ models are trained separately from one another, for example deploying a Bayesian training method. A respective training data set for ANN2₁ includes process parameters yⱼ and predetermined product quality parameters Qᵢ as target variables. A plurality of training data sets can be used for each product j. In step S1, the same training process occurs for model ANN2₂, wherein the process parameters y₂ are included as target variables designed or measured product quality parameters Q₂ are deployed. For example, due to a limited amount of training data and the missing educt impact input, models ANN2₁ and ANN2₂ will produce residuals or errors in their quality prediction.

In a next step S2, the residuals of the target variables, i.e. Q₁ and Q₂, are calculated.

Next, in step S3, the ANN model ANN1 is trained based on training data sets that include the educt quality parameters xᵢ, and, as target variable for the training of the residuals obtained in step S2. The training of ANN1 in step S3 occurs for all available products j. Hence, the influence of the educt quality parameters and the influence of various process parameters are separated within the ANN model architecture. It is an advantage that the ANN modeling or predicting the impact of the educt parameters can be trained by a larger data set stemming from the processing of the first product along y; and the second product along y₂. One may contemplate considering training data sets for the educt model ANN1 for further batch processes leading to further products.

In the next step S4, the second ANNs implementing models ANN 2₁ and ANN 2₂ are retrained. The additional training in step S3 uses additional input off the predicted residuals obtained from the first model ANN1. Hence, the accuracy of the prediction of the product quality parameters Q₁ and Q₂ are further improved.

In embodiments, the steps S3 and S4 are performed repeatedly. Due to the architecture of the ANN system 7, 8, sparse training data sets can be handled and still allow for a robust blackbox model for controlling a batch plant. In particular, in multiple product batch plants, the ANN configuration data may be reused or recycled if shared or often used educts are deployed.

FIG. 7 shows a schematic diagram of an embodiment for a control system for a batch plant using the ANN systems 7, 8 or improvements thereof. FIG. 7 shows a control device 13 coupled to a batch plant, as for example shown in FIG. 1. Like or similar reference numerals are used and not expressly explained again. The control device 13 receives educt quality parameters xᵢ and predetermined product quality parameters Q′ₚ, where the predetermined product quality parameters refer to a desired quality of the product that is produced by the reactor 2. The reactor 2 is operated and/or characterized by process parameters yₚ for the specific product p. The control device 16 is, for example, a computer-implemented device that performs operations implementing an ANN system as disclosed before or in the following. The control device 13 further carries out an optimization algorithm such that an observed quality parameter Qₚ for the product matches with the predetermined product quality according to the product quality parameter Q′ₚ. Next, various aspects of simulating/controlling a plant shown in FIG. 7 are elaborated.

FIG. 5 shows an ANN system or set-up or architecture capable of simulating a variety of products having product quality parameters Q₁, Q₂ and Q₃ based on a plurality of educts and their associated educt quality parameters X_{1,2,3,4}, f_{1,2,3,4} refers to the ANN educt model corresponding to the first ANNs, for example in FIG. 3, ANN1, and g_{1,2,3} refers to process models implemented by the second ANNs (e.g. ANN2₁ and ANN2₂ in FIG. 3). h_{1,2,3} refers to linear regressors that model the chemical reaction involving a sample of educts. For example, regressor h₁ receives the output from educt models f₁ and f₂. One may generalize the architecture shown in FIG. 5 having a plurality of first ANNs instead of only four indicated by f₁, f₂, f₃ and F₄, and corresponding to an educt characterized by educt quality parameters X₁, X₂, X₃ and X₄, respectively. Then a plurality of second ANNs of which three are labeled by g₁, g₂ and g₃ receive the combination of weighted educt impact parameters R₁, R₂, R₃ and R₄ and specific process parameters y₁, y₂, y₃ corresponding to the batch process leading to a respective product 1, 2, 3 having associated product quality parameters Q₁, Q₂, Q₃ Generally, one may consider j=1 . . . p products and i=1 . . . m educts.

A representation of a general algorithm using regression models based on ANNs is shown in FIG. 6. The algorithm 1 shown in FIG. 6, in particular, provides for a training method for a generalized ANN architecture based on the ANN systems 7, 8 and 12. It is assumed that there are nⱼ samples or data sets of a production process for product j. The input parameters for the model are labeled as equation 4:

$$( {x}_{1}^{( j )} , {y}_{1}^{( j )} ) , ( {x}_{2}^{( j )} , {y}_{2}^{( j )} ) , … , ( {x}_{{n}_{j}}^{( j )} , {y}_{{n}_{j}}^{( j )} ) \qquad ( equation 4 )$$

leading to corresponding target variables:

$${Q}_{1}^{( j )} , {Q}_{2}^{( j )} , … , {Q}_{{n}_{j}}^{( j )} . \qquad ( equation 5 )$$

As a result of the training algorithm, regressors or ANN models

$${\hat{P}}^{( 1 )} ( y , \tilde{Q} ( x ) ) , … , {\hat{P}}^{( p )} ( y , \tilde{Q} ( x ) ) ) \qquad ( equation 6 )$$

are obtained. \hat{P}^{(j)} stands for configuration data in terms of weights and biases for the individual ANNs used for simulating a specific batch process.

In lines 1 to 6 of algorithm 1 shown in FIG. 6, ANN models Q are obtained. Training of is based on the process parameter trainings sets y and the product quality parameter as target variable. This leads to residuals indicated in line 4 of algorithm 1. Hence, the model residuals of Q̅^{(j)} stemming from the process parameters are combined in a single data set for training the ANN models referring to the educts. The educt training occurs in line 7 taking educt quality parameter data for training as well as the obtained residuals from line 4.

Next, for all products p in lines 8 to 10 of algorithm 1, the regression model \hat{P}^{(j)} according to equation 4 is obtained.

Investigations of the applicant show that a suitable ANN architecture for the first and second ANN models are single hidden layer neural networks trained by Bayesian regulation. Hence, an efficient neural network-based simulation method and control capabilities for batch plants are obtained. Software libraries for implementing the disclosed ANN models and their training are available in a in a computer-implemented fashion. For example, one may refer to the MATLAB Deep Learning Toolbox for configuring and operating the ANNs disclosed herein.

It is an advantage of the disclosed methods and systems that a prediction of product qualities is available even if only sparse data sets are available. Investigations of the applicant show that simulation of batch plants based on the disclosed approach reaches accuracies similar or better than what is obtained from whitebox models if they are available. Hence, a flexible and efficient tool for simulating, predicting and controlling chemical processes, for example deployed in batch processing, is provided.

Although, simulations of batch plant operations are disclosed using ANNs in ANN systems the invention is not limited to such regressors. One may contemplate of alternative configurations of regression systems to perform regression, e.g. involving gaussian processes, linear regression, elastic net regularization models or the like. E.g. any ANN in this disclosure may be replaced by a suitable regressor unit. It is understood that the regressors may be implemented as software services, hardware units or distributed computer networks.

### USED REFERENCE SIGNS

1 batch plant
2 reactor
3, 5 educt
4, 6 product
7, 8, 12 ANN system
9, 10, 11 ANN
13 control device
S1 training second ANNs
S2 calculating residuals
S3 training first ANN
S4 retraining second ANNs

1. A computer-implemented regressor for simulating, monitoring and/or controlling a plant, wherein the plant is implemented:
to receive one or more educts having associated educt quality parameters (x₁, x₂),
to process said educt(s) wherein the process has associated process parameters (y), and
to output a product having associated product quality parameters (Q₁, Q₂);
and the regressor comprises:
at least two regressor units, each regressor unit comprising:
an input for receiving input data, and
an output for outputting output data,
wherein:
a first regressor unit is implemented to receive said educt quality parameters (xᵢ) and to output at least one educt impact parameter (R₁); and
a second regressor unit is implemented to receive said educt impact parameter (R₁) and said process parameters (yⱼ) and to output at least one product quality parameter (Qⱼ); and
the first and the second regressor unit are based on machine-learning principles.

2. The regressor of claim 1, wherein the first and second regressor units are artificial neural networks (“ANN”), each including an input layer having input nodes for receiving input data, and an output layer having output nodes for outputting output data, wherein
the second ANN is trained based on training data sets including process parameters and product target variables corresponding to a product quality parameter associated to a respective product.

3. The regressor of claim 2, wherein the first ANN is trained based on training data sets including the educt quality parameters and a residual of the trained second ANN as target variable for the educt impact parameter, both corresponding to the respective product.

4. The regressor of claim 1, comprising:
a plurality of first ANNs, wherein each ANN of the first ANNs corresponds to an educt and is implemented to receive corresponding educt quality parameters (X_{i=1 . . . 4}) and to output at least one corresponding educt impact parameter (R_{i=1 . . . 4}); and
a plurality of second ANNs, wherein each ANN of the second ANNs corresponds to a process for producing a product and is implemented to receive corresponding process parameters (Y_{j=1 . . . 3}) and a combination of educt impact parameters (R_{i=1 . . . 4}) from the first ANNs, and to output a corresponding product quality parameter (Q_{j=1 . . . 3}).

5. The regressor of claim 1, wherein at least one of the ANNs is a feed forward ANN, a Baysian neural network and/or at least one of the ANNs further comprises hidden nodes.

6. The regressor of claim 1, wherein said educt quality parameter comprises at least one of a viscosity value, a hydroxyl value, a concentration value, and a color parameter.

7. The regressor of claim 1, wherein said process parameters (yⱼ) comprise at least one of a measured observable, a temperature value, a maximum temperature value, a time span, a reaction time, a storage time of a catalyst, a number of free isocyanate (NCO) groups, and characteristics of a time series.

8. The regressor of claim 1, wherein said product quality parameters (Qⱼ) comprise at least one of a viscosity value, a hardness value, a roughness value, drug interaction, a pH value, and a solubility.

9. A control device for controlling a plant, wherein the plant is implemented:
to receive one or more educts having associated educt quality parameters (xᵢ),
to process said educt(s) wherein the process has associated process parameters (yⱼ), and to output a product having associated product quality parameters (Qⱼ);
wherein the control device comprises a regressor of claim 1, wherein the control device is implemented to adapt the process as a function of the product quality parameter (Qⱼ) output from the regressor unit in response to adapted process parameters.

10. The control device of claim 9, wherein the control device comprises a computer processing device implemented to perform operations implementing the regressor and to carry out an optimization algorithm for adapting process parameters such that the product quality parameters (Qⱼ) output from the regressor unit correspond to a predetermined product quality.

11. A method for training the regressor of claim 1, wherein the regressor units are machine learning units, the method comprising:
providing for a first and at least one second product (j=1 . . . p), a plurality of nₚ training data sets, each training data set including educt quality parameters (x), process parameters (y) and a product target variable (Q) corresponding to a product quality parameter associated to the product (j); training the second regressor unit and/or a third regressor unit based on training data subsets including the process parameters (y)
and the product target variables (Q), corresponding to a first product (j=1), thereby
obtaining a first residual (R) for each training data subset;
training the regressor unit (10) based on training data subsets including the process parameters (y) and the product target variables (Q), corresponding to at least one further product (j≠1), thereby obtaining a second residual (R) for each training data subset; and
training the first regressor unit based on training data subsets including the educt quality parameters (x) and the residual (R) as target variable for the educt impact parameter, both corresponding to the first product (j=1), and on further training data subsets including the educt quality parameters (x) and the residual (R) as target variable for the educt impact parameter, both corresponding to the at least one further product (j≠1).

12. The method of claim 11, further comprising:
for each product (j), training the second regressor unit based on training data subsets including the process parameters (y), the educt impact parameter output from the trained first ANN (9) in response to the educt quality parameters (x) associated to the educt used for producing the respective product, and the product target variable (Q) corresponding to the product quality parameter associated to the respective product.

13. The method of claim 12, wherein the step of training the first regressor unit and the step of training the second regressor unit are repeatedly carried out.

14. The method of claim 11, further comprising:
generating said training data sets by operating the plant and measuring process parameters and product quality parameters; and/or generating said training data sets deploying a whitebox-numerical model for simulating a plant process based on educt quality parameters and generating process parameters, and product quality parameters.

15. A method for simulating, monitoring and/or controlling a plant, wherein the plant is implemented:
to receive one or more educts having associated educt quality parameters (xᵢ),
to process said educt(s) wherein the process has associated process parameters (yⱼ), and to output a product having associated product quality parameters (Qⱼ);
and the method comprises:
using a regressor of claim 1, wherein the regressor is trained according to the method of claim 11.
